(19) United States
(12) Patent Application Publication
(10) Pub. No.: US 2012/0147007 A1
(43) Pub. Date: Jun. 14, 2012

(54) APPARATUS AND METHOD FOR TILE BINNING TO REDUCE POWER CONSUMPTION

(75) Inventors: Sang Oak Woo, Gyeonggi-do (KR); Seok Yoon Jung, Seoul (KR)

(73) Assignee: SAMSUNG ELECTRONICS CO., LTD., Suwon-si (KR)

(21) Appl. No.: 13/323,210

(22) Filed: Dec. 12, 2011

(30) Foreign Application Priority Data
Dec. 13, 2010 (KR) 10-2010-0126794

(51) Int. Cl. G06T 15/00; G06T 11/20

(52) U.S. Cl. 345/426; 345/441

(57) ABSTRACT

Described is a tile binning apparatus and method which consumes a low amount of power. The tile binning apparatus may determine whether to perform an overlap test that reduces an overlap factor, based on whether one or more tiles overlapping a bounding box of a triangle obtained as a result of geometry processing is one-dimensional. As a result, an unnecessary operation may be avoided which may reduce an amount of consumed power.

### CROSS-REFERENCE TO RELATED APPLICATIONS

This application claims the priority benefit of Korean Patent Application No. 10-2010-0126794, filed on Dec. 13, 2010, in the Korean Intellectual Property Office, the disclosure of which is incorporated herein by reference.

### BACKGROUND

1. Field

Example embodiments relate to a tile binning apparatus and method which consumes a reduced amount of power. More particularly, example embodiments relate to an apparatus and method that may determine whether to perform an operation to reduce an overlap factor. The determination may be based on whether a tile overlapping a bounding box of a triangle for a three-dimensional (3D) rendering is one-dimensional (1D), and consequently, this determination may decrease an amount of consumed power.

2. Description of the Related Art

Three-dimensional (3D) rendering technologies have recently been developed and may be applied to a mobile multi-media device. Mobile multi-media devices typically operate various applications with a limited amount of power. Therefore, it is desirable to perform 3D rendering in a manner which results in low power consumption.

3D rendering may perform many operations to display a 3D object on a two-dimensional (2D) plane. Particularly, a triangle may be obtained as a result of geometry processing with respect to the 3D object, and information associated with an overlap between the triangle and a tile on the 2D plane may be important. For example, as a degree of the overlap between the triangle and the tile on the 2D plane increases, a number of read operations with respect to a memory increases and thus, a larger amount of power may be consumed.

The amount of power consumed by using the memory may decrease by additionally performing an operation of reducing an overlap factor that indicates the degree of the overlap between the triangle and the tile on the 2D plane. However, the operation of reducing the overlap factor may also include an additional operation. Therefore, there is a desire for a criterion to determine whether to perform the operation of reducing the overlap factor.

### SUMMARY

The foregoing and/or other aspects are achieved by providing a tile binning apparatus, including a first overlap testing unit to output one or more tiles overlapping a bounding box of a triangle obtained as a result of geometry processing, a power managing unit to manage, based on a result of the first overlap testing unit, power of a second overlap testing unit that reduces an overlap factor of the triangle, and the second overlap testing unit to reduce the overlap factor of the triangle based on an operation of the power managing unit.

The foregoing and/or other aspects are achieved by providing a tile binning apparatus, including a one-dimensional (1D) tile determining unit to determine, based on a result of a first overlap testing unit, whether one or more tiles overlapping a bounding box of a triangle is 1D, a power adjusting unit to turn power of a second overlap testing unit, on and off, based on whether the one or more tiles is 1D, and the first overlap testing unit outputs the one or more tiles overlapping the bounding box of the triangle obtained as a result of geometry processing, and the second overlap testing unit reduces an overlap factor of the triangle.

The foregoing and/or other aspects are achieved by providing a tile binning method, including outputting, by a first overlap testing unit, a tile overlapping a bounding box of a triangle obtained as a result of geometry processing, managing, by a power managing unit, power of a second testing unit that reduces an overlap factor of the triangle, based on a result of outputting of the one or more tiles overlapping the bounding box of the triangle, and decreasing, by the second overlap testing unit, the overlap factor of the triangle based on an operation of the power managing unit.

The foregoing and/or other aspects are achieved by providing a tile binning method, including outputting, by a first overlap testing unit, one or more tiles overlapping a bounding box of a triangle obtained as a result of geometry processing, and determining, by a power managing unit, whether to operate the second overlap testing unit that reduces an overlap factor of the triangle, based on a result of outputting of the one or more tiles overlapping the bounding box of the triangle.

The foregoing and/or other aspects are achieved by providing a tile binning method, including determining, by a 1D tile determining unit, whether one or more tiles overlapping a bounding box of a triangle is 1D, based on a result of a first overlap testing unit, and turning on and off, by a power adjusting unit, power of a second overlap testing unit based on whether the one or more tiles is 1D, and the first overlap testing unit outputs the one or more tiles overlapping the bounding box of the triangle obtained as a result of geometry processing, and the second overlap testing unit reduces an overlap factor of the triangle.

Additional aspects of embodiments will be set forth in part in the description which follows and, in part, will be apparent from the description, or may be learned by practice of the disclosure.

The example embodiments may include a method and apparatus that may determine whether to perform an additional operation that reduces an overlap factor of a triangle, based on whether one or more tiles overlapping a bounding box of a triangle is one-dimensional and consequently, may prevent power from being wasted.

### BRIEF DESCRIPTION OF THE DRAWINGS

These and/or other aspects will become apparent and more readily appreciated from the following description of embodiments, taken in conjunction with the accompanying drawings of which:

FIG. 1 is a block diagram illustrating a three-dimensional (3D) rendering apparatus according to example embodiments;

FIG. 2 is a block diagram illustrating a tile binning unit of FIG. 1 according to example embodiments;

FIG. 3 is a block diagram illustrating a power managing unit of FIG. 2 according to example embodiments;

FIG. 4 illustrates a case where a tile overlapping a bounding box of a triangle is a one-dimensional (1D) tile according to example embodiments;

FIG. 5 illustrates a process that reduces an overlap factor according to example embodiments;

FIG. 6 illustrates an operation of a second overlap testing unit that reduces an overlap factor according to example embodiments;

FIG. 7 illustrates an operation of a second overlap testing unit that reduces an overlap factor according to other example embodiments;

FIG. 8 illustrates an operation of a second overlap testing unit that reduces an overlap factor according to still other example embodiments; and

FIG. 9 is a flowchart illustrating a tile binning method according to example embodiments.

### DETAILED DESCRIPTION

Reference will now be made in detail to embodiments, examples of which are illustrated in the accompanying drawings, wherein like reference numerals refer to like elements throughout. Embodiments are described below to explain the present disclosure by referring to the figures.

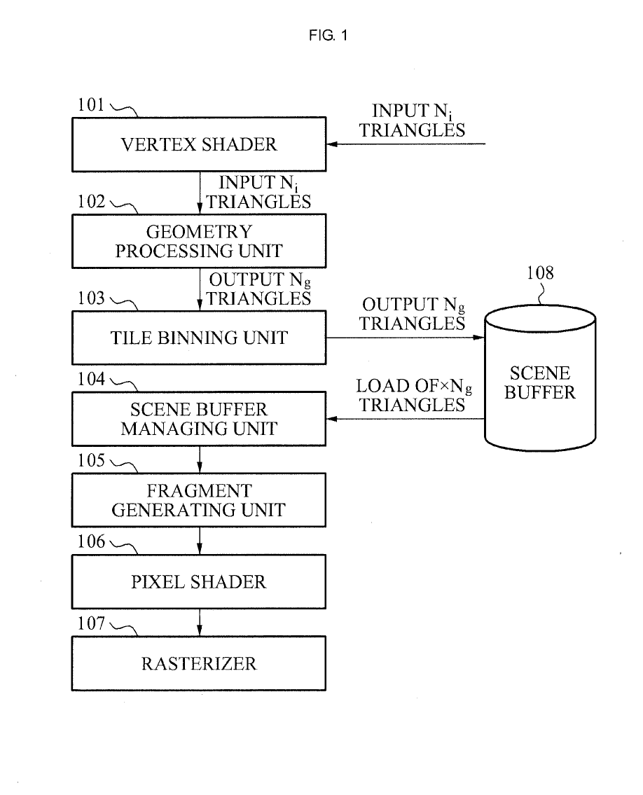

FIG. 1 illustrates a three-dimensional (3D) rendering apparatus according to example embodiments.

Referring to FIG. 1, the 3D rendering apparatus may include a vertex shader 101, a geometry processing unit 102, a tile binning unit 103, a scene buffer managing unit 104, a fragment generating unit 105, a pixel shader 106, a rasterizer 107, and a scene buffer 108.

When Nᵢ triangles are inputted from an outside user/source, the vertex shader 101 may perform shading with respect to respective vertexes of the inputted triangles. The vertex shader 101 may apply a shadow and a color pattern to the respective vertexes of the inputted triangles, to obtain a realistic graphic of an object.

The geometry processing unit 102 may perform clipping with respect to the Nᵢ triangles, may calculate a light source, and may perform coordinate transformation through a projection scheme and thus, may output N_{g} triangles. When not all the Nᵢ triangles exist in a clipping area, a number of triangles may increase due to the clipping.

The tile binning unit 103 may determine a tile overlapping inputted N_{g} triangles among a plurality of tiles constituting a two-dimensional (2D) plane. First, the tile binning unit 103 may determine a tile overlapping a triangle based on a bounding box surrounding the triangle. A number of triangles read from the scene buffer 108 may be equal to a multiplication between an overlap factor (OF) and N_{g}. In this example, the OF may indicate, as a numeral value, a degree of an overlap between a triangle and a tile. When the OF is high, the overlap between the triangle and the tile is large and thus, a number of read operations performed with respect to a memory may increase. Accordingly, an amount of consumed power may increase.

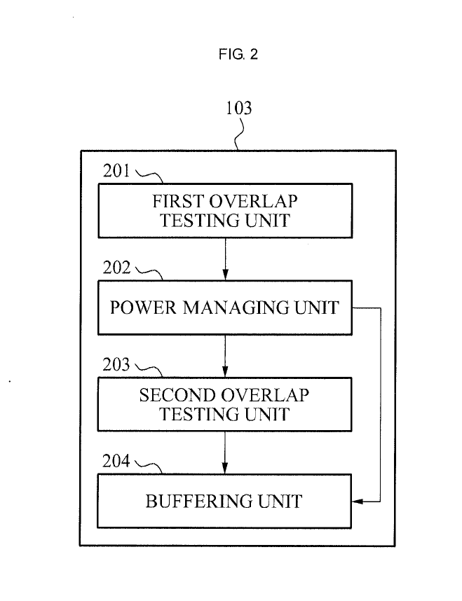

The tile binning unit 103 may additionally perform an operation of reducing the OF to decrease the amount of power consumed by the read operation performed with respect to the memory. However, the operation of reducing the OF may also consume power, and may not need to be performed in every instance. Therefore, the tile binning unit 103 may determine whether the tile overlapping the bounding box of the triangle is a 1D tile, and may perform the operation of reducing the OF based on the determination. Operations of the tile binning unit 103 will be described with reference to FIGS. 2 through 7.

The scene buffer managing unit 104 may load OF×N_{g} triangles among triangles stored in the scene buffer 108.

The fragment generating unit 105 may generate fragments with respect to the loaded OF×N_{g} triangles. A point on a screen may be referred to as a pixel, and a fragment may denote a unit managed by the 3D rendering apparatus, to determine a color of the pixel.

The pixel shader 106 may perform shading with respect to pixels included in a fragment. The rasterizer 107 may perform a rasterizing operation with respect to the shaded fragment.

FIG. 2 illustrates the tile binning unit 103 of FIG. 1 according to example embodiments.

Referring to FIG. 2, the tile binning unit 103 may include a first overlap testing unit 201, a power managing unit 202, a second overlap testing unit 203, and a buffering unit 204.

The first overlap testing unit 201 may output a tile overlapping a bounding box of a triangle obtained by geometry processing. In this example, the tile may be a tile included in a 2D plane to be used for rendering a 3D object.

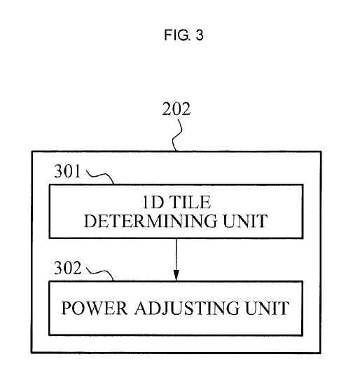

The power managing unit 202 may manage power to a second overlap testing unit 203 that reduces an OF of the triangle, based on a result of the first overlap testing unit 201. For example, the power managing unit 202 may turn power associated with an operation of the second overlap testing unit 203, on and off, based on the result of the first overlap testing unit 201, that is, based on whether the tile overlapping the bounding box of the triangle is a 1D tile. Operation of the power managing unit 202 will be described with reference to FIG. 3.

The second overlap testing unit 203 may reduce the OF of the triangle based on the operation of the power managing unit 202. The OF may indicate, as a numeral value, a degree of an overlap between the triangle and the tile. When the OF is high, a number of tiles overlapping the triangle may increase. Accordingly, a magnitude of tile binning information may increase and thus, a number of read operations performed with respect to a memory may increase and an amount of consumed power may consequently increase.

Accordingly, the second overlap testing unit 203 may decrease the number of read operations performed with respect to the memory by reducing the OF. However, the operation of reducing the OF may include an additional operation and thus, power may be consumed.

Accordingly, the power managing unit 202 may manage power associated with the operation of the second overlap testing unit 203, based on the result of the first overlap testing unit 201.

The buffering unit 204 may output, to the memory, data associated with the triangle and tile binning information.

FIG. 3 illustrates the power managing unit 202 of FIG. 2 according to example embodiments.

Referring to FIG. 3, the power managing unit 202 may include a 1D tile determining unit 301 and a power adjusting unit 302.

The 1D tile determining unit 301 may determine, based on the result of the first overlap testing unit 201, whether a tile overlapping a bounding box of a triangle is 1D. For example, the 1D tile determining unit 301 may determine that the tile is 1D when the tile includes the entire triangle. The 1D tile determining unit 301 may determine that the tile is 1D when a minimum value of an x axis of the tile is equal to a maximum value of the x axis or a minimum value of a y axis is equal to a maximum value of the y axis.

The power adjusting unit 302 may turn power of the second overlap testing unit 203, on and off, based on whether the tile overlapping the bounding box of the triangle is 1D. The power adjusting unit 302 may turn off the power of the second overlap testing unit 203 when the tile is 1D, and may turn on the power of the second overlap testing unit 203 when the tile is not 1D. When the tile is 1D, there is no need to operate the second overlap testing unit 203 to reduce the OF. Therefore, when the tile overlapping the bounding box of the triangle is 1D, the power adjusting unit 302 may turn off power to prevent operation of the second overlap testing unit 203.

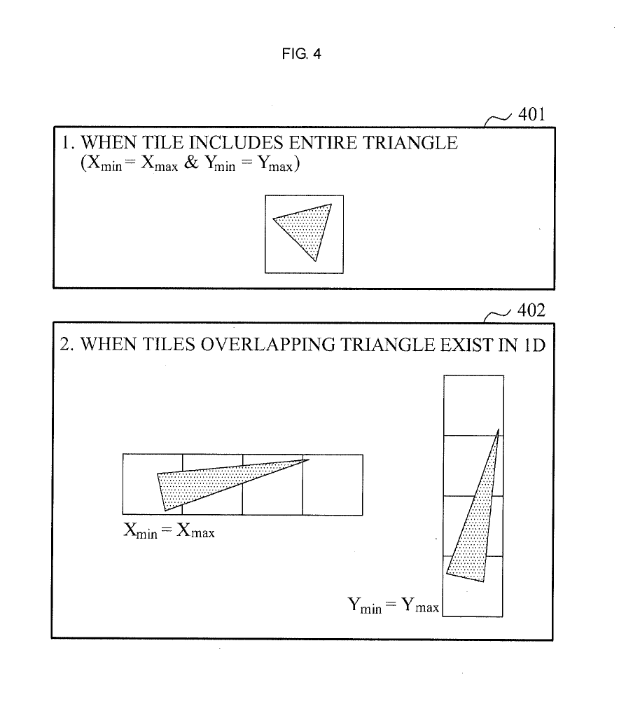

FIG. 4 illustrates a case where a tile overlapping a bounding box of a triangle is a 1D tile according to example embodiments.

Referring to data 401, a single tile includes the entire triangle. The data 401 may indicate that a number of tiles overlapping the bounding box of the triangle is one. Accordingly, Xₘᵢₙ and Xₘₐₓ of the tile have the same value, and Yₘᵢₙ and Yₘₐₓ of the tile have the same value.

Referring to data 402, the bounding box of the triangle overlaps four tiles. The data 402 may indicate that an x-axis or a y-axis of the tiles is in a single line. Accordingly, Xₘᵢₙ and Xₘₐₓ of the tiles have the same value, or Yₘᵢₙ and Yₘₐₓ of the tiles have the same value.

In this example, the tile overlapping the bounding box of the triangle is 1D and thus, an operation of reducing the OF of the triangle may not be needed. Therefore, the power managing unit 202 may turn off power of the second overlap testing unit 203 that reduces the OF of the triangle, to prevent an operation of the second overlap testing unit 203.

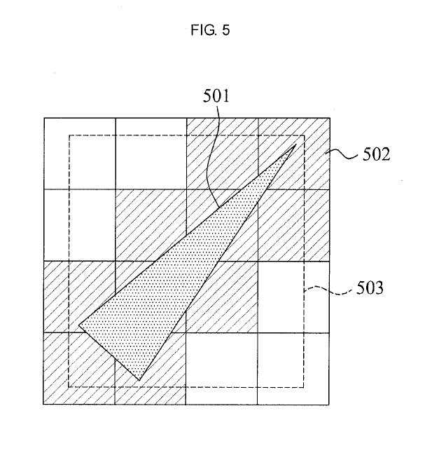

FIG. 5 illustrates a process that reduces an OF according to example embodiments.

Referring to FIG. 5, a number of tiles overlapping a bounding box 503 of a triangle 501 may be 16. Tiles overlapping the triangle 501 may be shaded, for example, a tile 502, and a number of the tiles overlapping the triangle 501 may be 10. Accordingly, the first overlap testing unit 201 may output the tiles overlapping the bounding box 503 of the triangle 501, and the second overlap testing unit 203 may reduce the OF and may output the tiles overlapping the triangle 501.

However, an operation of reducing the OF may not need to be performed with respect to every triangle. As described above, when a tile overlapping a bounding box of a triangle is 1D, a result of the first overlap testing unit 201 may be the same as a result of the second overlap testing unit 203. In this example, only the first overlap testing unit 201 may operate and thus, an amount of power consumed by an operation of the second overlap testing unit 203 may not be wasted.

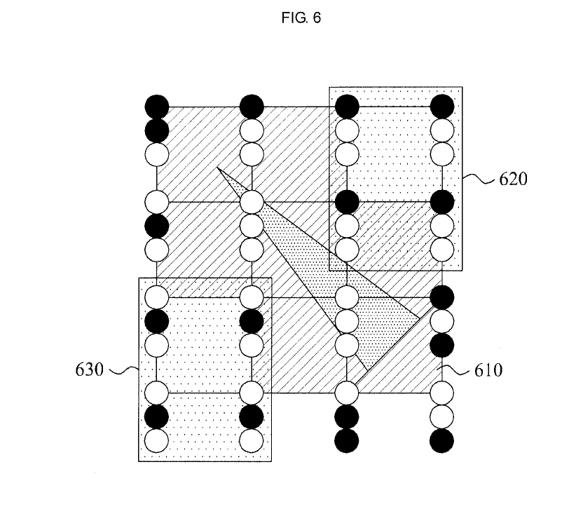

FIG. 6 illustrates an operation of the second overlap testing unit 203 that reduces an OF according to example embodiments.

Referring to FIG. 6, the second overlap testing unit 203 may reduce an OF based on a half-plane edge function. Based on the half-plane edge function, a discriminant value of a vertex existing on the right side of a straight line may be expressed as a positive number and a discriminant value of a vertex existing on the left side of the straight line may be expressed as a negative number.

Three identification (ID) symbols marked on a vertex of a tile may denote a first discriminant value, a second discriminant value, and a third discriminant value obtained, based on the half-plane edge function, with respect to the vertex, respectively. A white ID symbol may denote a vertex of which a discriminate value is a positive value. A black ID symbol may denote a vertex of which a discriminate value is a negative value.

First discriminant values, second discriminant values, and third discriminant values of vertexes of a tile corresponding to an area 610 are different from each other, and the first discriminant values, the second discriminant values, and the third discriminant values of the vertexes include positive and negative numbers. Accordingly, the tile corresponding to the area 610 may include one of edges of the triangle and thus, the tile may be determined as a tile including a part of the triangle.

First discriminant values with respect to vertexes of a tile corresponding to an area 620 are all negative numbers, and second discriminate values and third discriminant values with respect to vertexes of the tile corresponding to the area 620 are all positive numbers and thus, the tile corresponding to the area 620 may not include a part of the triangle.

First discriminant values and third discriminant values with respect to vertexes of a tile corresponding to an area 630 are all positive numbers, and second discriminate values with respect to vertexes of the tile corresponding to the area 630 are all negative numbers and thus, the tile corresponding to the area 630 may not include a part of the triangle.

Therefore, the second overlap testing unit 203 may accurately extract tiles overlapping the triangle.

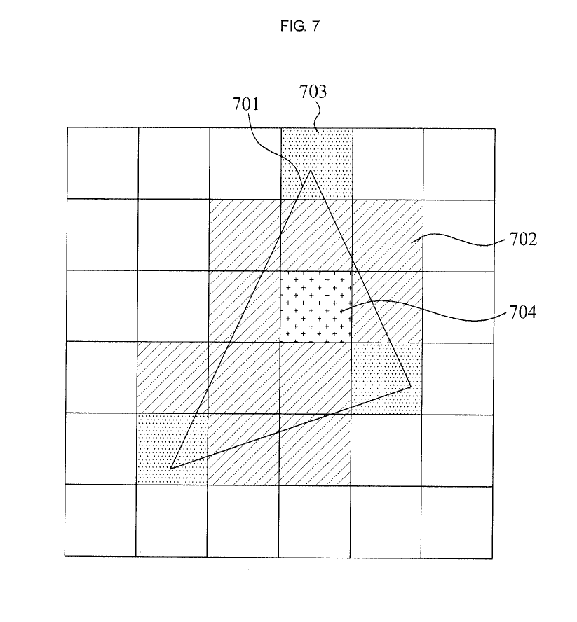

FIG. 7 illustrates an operation of the second overlap testing unit 203 that reduces an OF according to other example embodiments.

For example, the second overlap testing unit 203 may classify tiles overlapping a triangle 701 as a vertex tile, an edge tile, and an internal tile, and may reduce an OF.

Referring to FIG. 7, a number of vertex tiles including a vertex of the triangle 701, for example, a tile 703, may be three. A number of edge tiles including an edge of the triangle 701, for example, a tile 701, may be 10. A number of internal tiles that is included in the triangle 701, for example, a tile 704, may be one. Therefore, the tiles overlapping the triangle 701 may be classified as the vertex tile, the edge tile, and the internal tile, and remaining tiles may be determined as tiles not overlapping the triangle 701.

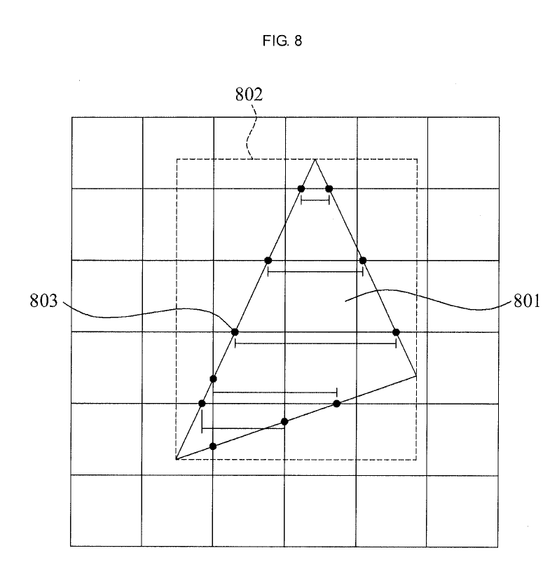

FIG. 8 illustrates an operation of the second overlap testing unit 203 that reduces an OF according to still other example embodiments.

For example, the second overlap testing unit 203 may reduce the OF based on a point where an edge of a triangle meets a boundary of a tile in a bounding box of the triangle. The second overlap testing unit 203 may detect a point where an edge of a triangle meets a boundary of a tile in the bounding box of the triangle, and may determine that a tile existing in a range between a minimum value and a maximum value of the point overlaps the triangle.

Referring to FIG. 8, the second overlap testing unit 203 may detect a point 803 where an edge of a triangle 801 meets a boundary of a tile in a bounding box 802 of the triangle 801, and may determine that a tile existing in a range between a minimum value and a maximum value of the point overlaps the triangle 801.

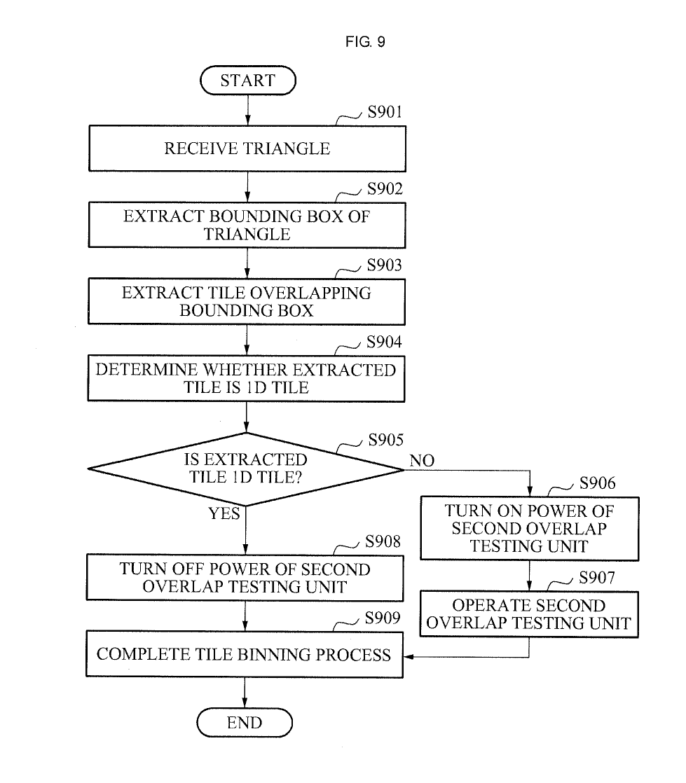

FIG. 9 illustrates a tile binning method according to example embodiments.

In operation 901, a tile binning apparatus may receive a triangle. In this example, the triangle may be obtained by geometry processing with respect to a 3D object. In operation 902, the tile binning apparatus may extract a bounding box of the triangle. In operation 903, the tile binning apparatus may extract a tile overlapping the bounding box of the triangle.

In operations 904 and 905, the tile binning apparatus may determine whether the extracted tile is a 1D tile. When the extracted tile is the 1D tile, the tile binning apparatus may turn off power of a second overlap testing unit that reduces an OF in operation 908. Conversely, when the extracted tile is not the 1D tile, the tile binning apparatus may turn on the power of the second overlap testing unit that reduces the OF in operation 906, and the second overlap testing unit may operate in operation 907.

In operation 909, when the tile binning process is completed, information associated with a tile actually overlapping the triangle may be outputted.

The apparatus and method for tile binning to reduce power consumption according to the above-described example embodiments may use one or more processors, which may include a microprocessor, central processing unit (CPU), digital signal processor (DSP), or application-specific integrated circuit (ASIC), as well as portions or combinations of these and other processing devices.

The example embodiments described herein refer to flowchart illustrations of the apparatus and method for tile binning to reduce power consumption. It will be understood that each block of the flowchart illustrations, and combinations of blocks in the flowchart illustrations, can be implemented by computer program instructions. These computer program instructions can be provided to one or more processors of a general purpose computer, special purpose computer, or other programmable data processing apparatus to produce a machine, such that the instructions, which execute via the one or more processors of the computer or other programmable data processing apparatus, may implement the functions specified in the flowchart block or blocks.

Each block of the flowchart illustrations may represent a unit, module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

The terms “module”, and “unit,” as used herein, may refer to, but is not limited to, a software or hardware component, such as a Field Programmable Gate Array (FPGA) or Application Specific Integrated Circuit (ASIC), which performs certain tasks. A module or unit may be configured to reside on an addressable storage medium and configured to execute on one or more processors. Thus, a module or unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules/units may be combined into fewer components and modules/units or further separated into additional components and modules.

The method according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules to perform the operations of the above-described embodiments, or vice versa.

The disclosure herein has provided example embodiments of a tile binning apparatus and method, which may be applied to mobile multi-media device, however the disclosure is not so limited. For example, the tile binning apparatus and method may be applied to technologies other than a mobile multi-media device, which may utilize three-dimensional rendering. For example, the device need not be mobile. For example, the tile binning apparatus and method may be used to perform 3D rendering in any device where it is desirable to conserve or reduce the consumption of power, however again, the disclosure is not so limited.

Although example embodiments have been shown and described, it would be appreciated by those skilled in the art that changes may be made in these embodiments without departing from the principles and spirit of the disclosure, the scope of which is defined by the claims and their equivalents.

What is claimed is:

1. A tile binning apparatus, comprising:
a first overlap testing unit to output one or more tiles overlapping a bounding box of a triangle obtained as a result of geometry processing;
a power managing unit to manage, based on a result of the first overlap testing unit, power of a second overlap testing unit; and
the second overlap testing unit to reduce an overlap factor of the triangle based on an operation of the power managing unit.

2. The tile binning apparatus of claim 1, wherein the power managing unit comprises:
a one-dimensional (1D) tile determining unit to determine, based on a result of the first overlap testing unit, whether the one or more tiles overlapping the bounding box of the triangle is 1D; and
a power adjusting unit to turn power of the second overlap testing unit, on and off, based on whether the one or more tiles is 1D.

3. The tile binning apparatus of claim 2, wherein, when the one or more tiles includes the entire triangle, the 1D tile determining unit determines that the one or more tiles is 1D.

4. The tile binning apparatus of claim 2, wherein, when a minimum value of an x axis of the one or more tiles is equal to a maximum value of the x axis, or a minimum value of a y axis of the one or more tiles is equal to a maximum value of the y axis, the 1D tile determining unit determines that the one or more tiles is 1D.

5. The tile binning apparatus of claim 2, wherein the power adjusting unit comprises:
turning off the power of the second overlap testing unit when the one or more tiles is 1D; and
turning on the power of the second overlap testing unit when the one or more tiles is not 1D.

6. The tile binning apparatus of claim 1, wherein the second overlap testing unit reduces the overlap factor, based on a half-plane edge function.

7. The tile binning apparatus of claim 1, wherein the second overlap testing unit reduces the overlap factor by classifying the one or more tiles overlapping the triangle as one of a vertex tile, an edge tile, and an internal tile.

8. The tile binning apparatus of claim 1, wherein the second overlap testing unit reduces the overlap factor based on a point where an edge of the triangle meets a boundary of one or more tiles in the bounding box of the triangle.

9. The tile binning apparatus of claim 1, further comprising a buffering unit to output to a memory data associated with the triangle and tile binning information.

10. A tile binning apparatus, comprising:
a one-dimensional (1D) tile determining unit to determine, based on an output of one or more tiles overlapping a bounding box of a triangle received from a first overlap testing unit, whether the one or more tiles overlapping the bounding box of the triangle is 1D; and
a power adjusting unit to turn power of a second overlap testing unit, on and off, based on whether the one or more tiles is 1D.

11. The tile binning apparatus of claim 10, wherein the second overlap testing unit reduces an overlap factor of the triangle.

12. The tile binning apparatus of claim 10, wherein the 1D tile determining unit determines the one or more tiles is 1D, when a condition satisfies one of a case where the one or more tiles includes the entire triangle, a case where a minimum value of an x axis of the one or more tiles is equal to a maximum value of the x axis, or a case where a minimum value of a y axis of the one or more tiles is equal to a maximum value of the y axis.

13. The tile binning apparatus of claim 10, wherein the power adjusting unit turns off the power of the second overlap testing unit, when the one or more tiles is 1D, and turns on the power of the second overlap testing unit, when the one or more tiles is not 1D.

14. A tile binning method, comprising:
outputting, by a first overlap testing unit, one or more tiles overlapping a bounding box of a triangle obtained as a result of geometry processing;
managing, by a power managing unit, power of a second overlap testing unit based on a result of the outputting; and
decreasing, by the second overlap testing unit, the overlap factor of the triangle based on an operation of the power managing unit.

15. The tile binning method of claim 14, wherein the managing comprises:
determining, by a one-dimensional (1D) tile determining unit, whether the one or more tiles overlapping the bounding box of the triangle is 1D, based on a result of the first overlapping test unit; and
turning on and off, by the power adjusting unit, the power of the second overlap testing unit based on whether the one or more tiles is 1D.

16. The tile binning method of claim 15, wherein the determining comprises:
determining that the one or more tiles is 1D when the one or more tiles includes the entire triangle.

17. The tile binning method of claim 15, wherein the determining comprises:
determining that the one or more tiles is 1D, when a minimum value of an x axis of the one or more tiles is equal to a maximum value of the x axis, or a minimum value of a y axis of the one or more tiles is equal to a maximum value of the y axis.

18. The tile binning method of claim 15, wherein the turning on and off comprises:
turning off the power of the second overlap testing unit when the one or more tiles is 1D; and
turning on the power of the second overlap testing unit when the one or more tiles is not 1D.

19. The tile binning method of claim 14, wherein the decreasing comprises:
decreasing the overlap factor based on the half-plane edge function.

20. The tile binning method of claim 14, wherein the decreasing comprises:
decreasing the overlap factor by classifying the one or more tiles overlapping the triangle as one of a vertex tile, an edge tile, and an internal tile.

21. The tile binning method of claim 14, wherein the decreasing comprises:
decreasing the overlap factor based on a point where an edge of the triangle meets a boundary of the one or more tiles in the bounding box of the triangle.

22. The tile binning method of claim 14, further comprising outputting, by a buffering unit, data associated with the triangle and tile binning information to a memory.

23. A tile binning method, comprising:
outputting, by a first overlap testing unit, one or more tiles overlapping a bounding box of a triangle obtained as a result of geometry processing; and
determining, by a power managing unit, whether to operate a second overlap testing unit that reduces an overlap factor of the triangle, based on a result of the outputting.

24. A tile binning method, comprising:
outputting, by a first overlap testing unit, one or more tiles which overlap a bounding box of a triangle;
determining, by a one-dimensional (1D) tile determining unit, whether the one or more tiles overlapping the bounding box of the triangle is 1D;
turning on and off, by a power adjusting unit, power of a second overlap testing unit based on whether the one or more tiles is 1D; and
selectively reducing, by the second overlap testing unit, an overlap factor of the triangle based on whether power is applied to the second overlap testing unit.

25. The tile binning method of claim 24, wherein the determining comprises:
determining that the one or more tiles is 1D, when a condition satisfies one of a case where the one or more tiles includes the entire triangle, a case where a minimum value of an x axis of the one or more tiles is equal to a maximum value of the x axis, or a case where a minimum value of a y axis of the one or more tiles is equal to a maximum value of the y axis.

26. The tile binning method of claim 24, wherein the turning on and off comprises:
turning off the power of the second overlap testing unit when the one or more tiles is 1D; and p1 turning on the power of the second overlap testing unit when the one or more tiles is not 1D.

27. A non-transitory computer-readable medium comprising a program, that when executed, instructs a computer to perform the method of claim 14.

28. A tile binning method, comprising:
receiving a triangle obtained by geometry processing;
extracting a bounding box to surround the triangle;
extracting, by a first overlap testing unit, one or more tiles which overlap the bounding box of the triangle;
determining, by a one-dimensional (1D) tile determining unit, whether the one or more tiles overlapping the bounding box of the triangle is 1D,
turning power on to a second overlap testing unit when it is determined the one or more tiles is not 1D, wherein the second overlap testing unit reduces an overlap factor of the triangle;
turning power off to the second overlap testing unit when it is determined the one or more tiles is 1D, wherein the second overlap testing unit does not reduce an overlap factor of the triangle; and
outputting information associated with the one or more tiles overlapping the triangle.

29. A three-dimensional rendering apparatus, comprising:
a vertex shader to perform shading to vertexes of one or more triangles inputted to the vertex shader, and to output one or more triangles after performing the shading;
a geometry processing unit to perform geometry processing to the one or more triangles received from the vertex shader, and to output one or more triangles after performing the geometry processing;
a tile binning unit to receive the one or more triangles from the geometry processing unit, wherein the tile binning unit further comprises:
a first overlap testing unit to output one or more tiles overlapping a triangle from the one or more triangles received from the geometry processing unit, based on a bounding box surrounding the triangle;
a one-dimensional (1D) tile determining unit to determine, based on the output of the one or more tiles overlapping the bounding box of the triangle, whether the one or more tiles overlapping the bounding box of the triangle is 1D;
a power adjusting unit to turn power of a second overlap testing unit, on and off, based on whether the one or more tiles is 1D; and
the second overlap testing unit to reduce an overlap factor of the triangle if the power adjusting unit turns on the power to the second overlap testing unit,
a scene buffer to read one or more triangles from the tile binning unit based on the overlap factor; and
a scene buffer managing unit to receive the one or more triangles from the scene buffer.
